(19) United States
(12) Patent Application Publication
(10) Pub. No.: US 2022/0109245 A1
(43) Pub. Date: Apr. 7, 2022

(54) LENS ANTENNA MODULE AND ELECTRONIC DEVICE

(71) Applicant: GUANGDONG OPPO MOBILE TELECOMMUNICATIONS CORP., LTD., Dongguan, (CN)

(72) Inventor: Fan YANG, Dongguan (CN)

(21) Appl. No.: 17/550,966

(22) Filed: Dec. 14, 2021

Related U.S. Application Data
(63) Continuation of application No. PCT/CN2020/094653, filed on Jun. 5, 2020.

(30) Foreign Application Priority Data
Jun. 17, 2019 (CN) 201910524495.0

(51) Int. Cl. H01Q 15/08; H01Q 1/24; H01Q 3/26; H01Q 3/14

(52) U.S. Cl. CPC H01Q 15/08; H01Q 3/14; H01Q 3/2658; H01Q 1/243

(57) ABSTRACT

A lens antenna module is provided. The lens antenna module includes an array antenna and a plane lens. The array antenna includes multiple antenna elements arranged in an array. The multiple antenna elements are configured to emit/receive electromagnetic waves. The plane lens faces the multiple antenna elements and is located at one side of the multiple antenna elements where the electromagnetic waves are emitted/received. The plane lens is configured to refract the electromagnetic waves, and a refractive index of the plane lens to the electromagnetic waves is gradually varied. An electronic device is further provided in the disclosure.

### CROSS-REFERENCE TO RELATED APPLICATIONS

The present application is a continuation of International Application No. PCT/CN2020/094653, filed on Jun. 5, 2020, which claims priority to Chinese Patent Application No. 201910524495.0, filed on Jun. 17, 2019, the entire disclosures of which are incorporated herein by reference.

### TECHNICAL FIELD

This disclosure relates to the field of electronic technology, and in particular, to a lens antenna module and an electronic device.

### BACKGROUND

With the development of mobile communication technology, people have higher and higher requirements for data transmission rate and antenna signal bandwidth, and how to improve an antenna signal transmission quality and a data transmission rate of an electronic device has become a problem to be solved.

### SUMMARY

An electronic device is provided in the disclosure.

In an aspect, a lens antenna module is provided in this disclosure. The lens antenna module includes an array antenna and a plane lens. The array antenna includes multiple antenna elements arranged in an array, where the multiple antenna elements are configured to emit/receive electromagnetic waves. The plane lens faces the multiple antenna elements and is located at one side of the multiple antenna elements where the electromagnetic waves are emitted/received. The plane lens is configured to refract the electromagnetic waves, and a refractive index of the plane lens to the electromagnetic waves is gradually varied.

In another aspect, an electronic device is provided in this disclosure. The electronic device includes the lens antenna module provided above.

In yet another aspect, an electronic device is provided in this disclosure. The electronic device includes a middle frame and two millimeter-wave (mm-Wave) lens antenna modules. The two mm-Wave lens antenna modules is fixed on two opposite sides of the middle frame. The mm-Wave lens antenna module includes an mm-Wave array antenna and a plane lens. The mm-Wave array antenna includes multiple mm-Wave antenna elements arranged in an array and configured to emit/receive mm-Wave signals. The plane lens is fixed to the middle frame and faces one side of the multiple mm-Wave antenna elements where the multiple mm-Wave antenna elements emit/receive the mm-Wave signals. The plane lens is configured to refract the mm-Wave signals, and a refractive index of the plane lens to the electromagnetic waves is gradually varied.

### BRIEF DESCRIPTION OF THE DRAWINGS

To describe technical solutions in implementations of the disclosure more clearly, the following briefly introduces the accompanying drawings required for describing the implementations. Apparently, the accompanying drawings in the following description merely illustrate some implementations of the disclosure. Those of ordinary skill in the art may also obtain other drawings based on these accompanying drawings without creative efforts.

FIG. 1 is a schematic structural view of an electronic device provided in an implementation of the disclosure;

FIG. 2 is a schematic structural view of a lens antenna module in an electronic device provided in an implementation of the disclosure;

FIG. 3 is a schematic structural view of a lens antenna module provided in an implementation of the disclosure;

FIG. 4 is a schematic structural view of a plane lens provided in an implementation of the disclosure;

FIG. 5 is a schematic structural view of a plane lens provided in an implementation of the disclosure;

FIG. 6 is a schematic structural view of a plane lens provided in an implementation of the disclosure;

FIG. 7 is a schematic structural view of a plane lens provided in an implementation of the disclosure;

FIG. 8 is a schematic structural diagram illustrating a beam pointing of a first antenna element provided in an implementation of the disclosure;

FIG. 9 is a schematic structural diagram illustrating a beam pointing of a second antenna element provided in an implementation of the disclosure;

FIG. 10 is a schematic structural diagram illustrating a beam pointing of a third antenna element provided in an implementation of the disclosure;

FIG. 11 is a schematic structural diagram illustrating a beam pointing of a fourth antenna element provided in an implementation of the disclosure;

FIG. 12 is a schematic structural diagram illustrating a beam pointing of a fifth antenna element provided in an implementation of the disclosure;

FIG. 13 is a top view of a lens antenna provided in an implementation of the disclosure;

FIG. 14 is a side view of a lens antenna provided in an implementation of the disclosure;

FIG. 15 is a schematic structural view of a lens antenna module in an electronic device provided in another implementation of the disclosure.

### DETAILED DESCRIPTION

Technical solutions in implementations of the disclosure will be described clearly and completely hereinafter with reference to the accompanying drawings in the implementations of the disclosure. Apparently, the described implementations are merely some rather than all implementations of the disclosure. All other implementations obtained by those of ordinary skill in the art based on the implementations of the disclosure without creative efforts shall fall within the protection scope of the disclosure.

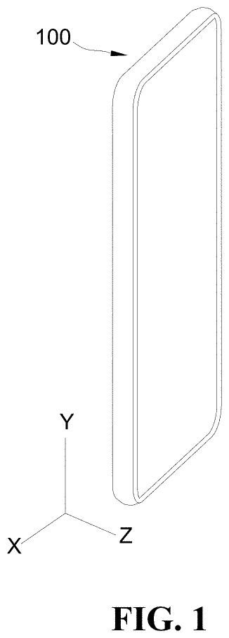

Referring to FIG. 1, FIG. 1 is a schematic diagram of a first viewing angle of an electronic device. The electronic device 100 may be a tablet computer, a mobile phone, a notebook computer, an in-vehicle device, a wearable device, a base station, a customer premise equipment (CPE), intelligence appliance, or any other products with antennas. In the disclosure, the mobile phone is taken as an example of the electronic device 100. For ease of description, the electronic device 100 is defined with reference to a first viewing angle. A width direction of the electronic device 100 is defined as an X-axis direction, a length direction of the electronic device 100 is defined as a Y-axis direction, and a thickness direction of the electronic device 100 is defined as a Z-axis direction.

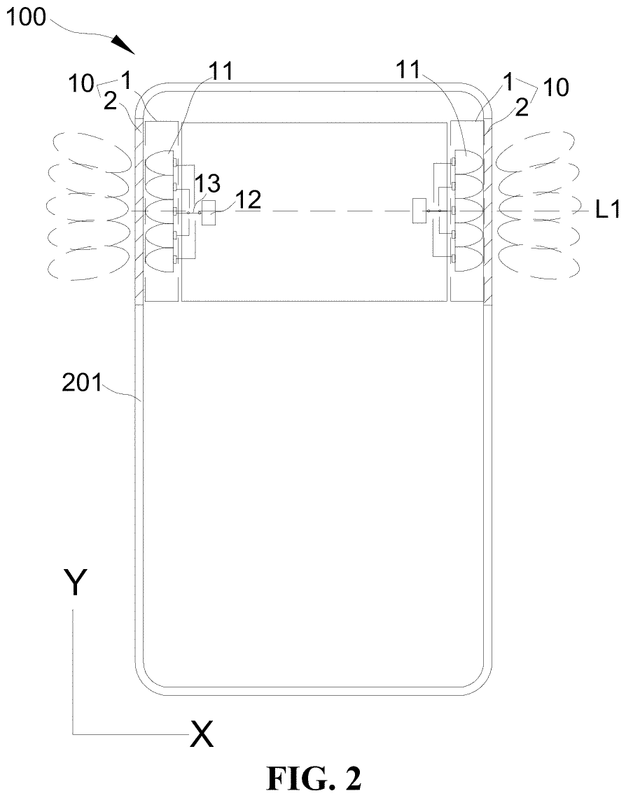

Referring to FIG. 2, a lens antenna module 10 is provided in the implementations of the disclosure. The lens antenna module 10 includes an array antenna 1 and a plane lens 2.

The array antenna 1 includes multiple antenna elements 11 arranged in an array. The antenna element 11 is configured to emit/receive an electromagnetic wave toward/from the plane lens 2. The multiple antenna elements 11 can be arranged in, but not limited to, a one-dimensional linear array and a two-dimensional matrix array. In this implementation, for example, the multiple antenna elements 11 are arranged in one-dimensional linear array in the Y-axis direction, which will not be repeated herein.

The plane lens 2 has two planar surfaces opposite to each other. One planar surface of the plane lens 2 faces the multiple antenna elements 11. The plane lens 2 is located at one side of the multiple antenna elements 11 where the electromagnetic waves are emitted/received. The plane lens 2 is configured to refract the electromagnetic waves emitted/received by the multiple antenna elements 11. The refractive index of the plane lens 2 to the electromagnetic waves is gradually varied. Optionally, a refractive index of the plane lens 2 to the electromagnetic waves gradually varies in the first direction, so that the electromagnetic waves emitted/received by the multiple antenna elements 11 are beam-formed in the first direction. The first direction is the Y-axis direction. It is noted that, in implementations of the disclosure, the plane lens 2 can be implemented as a plate lens 2. As an example, the plane lens 2 is a plate dielectric lens. The lens antenna module 10 in the disclosure can improve antenna signal transmission quality and data transmission rate.

By setting the plane lens 2 to face the array antenna 1, when the electromagnetic waves emitted/received by the multiple antenna elements 11 of the array antenna 1 pass through the plane lens 2, because the refractive index of the plane lens 2 to the electromagnetic waves gradually varies in the first direction, the phase compensation provided to the electromagnetic waves by the plane lens in the first direction gradually varies. In this way, by controlling a gradient trend of the refractive index of the plane lens 2 to the electromagnetic waves in the first direction, the electromagnetic waves emitted/received by the multiple antenna elements 11 can have the same phase in the first direction after passing through the plane lens 2, so that the plane lens 2 can beam form the electromagnetic wave beams in the first direction. Further, multiple beams with different beam pointing can be formed by controlling different antenna elements 11 to emit/receive electromagnetic waves toward/from different positions on the plane lens 2, so that beam scanning of the lens antenna module 10 is achieved.

Optionally, the multiple antenna elements 11 are arranged in the first direction, so that the multiple antenna elements 11 can emit/receive the electromagnetic waves toward/from different positions on the plane lens 2. The array antenna 1 includes but is not limited to a phased array antenna, a lens antenna, etc.

Optionally, the phased array antenna differs from the lens antenna as follows. The multiple antenna elements 11 in the phased array antenna are configured to emit/receive electromagnetic waves with different angles, and the beam scanning can be achieved. As such, the electromagnetic waves emitted/received by the multiple antenna elements 11 can radiate to different positions on the plane lens 2, and then beam forming of the beams with different angles can be achieved with aid of the plane lens 2 to further increase an antenna gain. The beam pointing of the beams emitted/received by the multiple antenna elements 11 in the lens antenna can be the same as or different from one another. When the beam pointing of the beams emitted/received by the multiple antenna element 11 in the lens antenna is the same, since the multiple antenna elements 11 are respectively located on an axis where a focal point of the plane lens 2 is located, deviate from the axis by a small distance, or deviate from the axis by a large distance, etc., the plane lens 2 deflects the beams emitted by the multiple antenna elements 11 located at different positions at different degrees, so that the beams are radiated out through the plane lens 2 at different angles, which improves a spatial coverage of the beams and facilitates beam scanning of the electromagnetic waves emitted/received by the lens antenna module 10.

Referring to FIG. 2, for example, the array antenna 1 is a lens antenna in this implementation, which will not be repeated again.

Optionally, referring to FIG. 2, the plane lens 2 may extend in a first direction. In other words, a length direction of the plane lens 2 is the first direction. In this implementation, for example, the first direction is the Y-axis direction. In other implementations, the first direction may also be the X-axis direction or the Z-axis direction. Optionally, the multiple antenna elements 1 are arranged in the first direction, so that the electromagnetic wave signals emitted/received by the multiple antenna elements 11 respectively radiate to different positions on the plane lens 2 in the length direction (i.e., the first direction).

Optionally, referring to FIG. 2, an orthographic projection of the plane lens 2 on a plane of the array antenna 1 covers multiple antenna elements 11, so that the electromagnetic wave signals emitted/received by the multiple antenna elements 11 can all radiate to the plane lens 2. Further, a transmission/reception range of the electromagnetic wave signals emitted/received by the multiple antenna elements 11 in the first direction matches a length of the plane lens 2. In other words, the transmission/reception range of the electromagnetic wave signals emitted/received by the multiple antenna elements 11 in the first direction is equal to the length of the plane lens 2, which can reduce a waste of some areas of the plane lens 2, improve the utilization of the plane lens 2, and make the plane lens 2 more compact and highly efficient.

Further, the refractive index of the plane lens 2 to the electromagnetic wave gradually varies in the first direction. By setting the refractive index of the plane lens 2 to the electromagnetic waves to be gradually varied in the first direction, the plane lens 2 can bring a gradually varied phase compensation to the electromagnetic waves, so that the electromagnetic waves radiated out through the plane lens 2 have the same phase, which can improve the directionality and increase gain of electromagnetic wave transmission/reception. As such, the beam forming of the electromagnetic waves emitted/received by the multiple antenna elements 11 in the first direction is achieved, which can concentrate electromagnetic wave energy and increase an electromagnetic wave gain. When the multiple antenna elements 11 are lens antennas, the electromagnetic wave signals emitted/received by the multiple antenna elements 11 radiate to different positions on the plane lens 2, and the plane lens 2 has different refractive indexes to the electromagnetic waves at different positions of the plane lens 2. In other words, the plane lens 2 brings different phase compensations for the electromagnetic waves emitted/received by different antenna elements 11, so that the electromagnetic waves emitted/received by different antenna elements 11 have different beam deflection angles after passing through the plane lens 2, and multiple beams with different deflection angles are obtained to achieve the beam scanning.

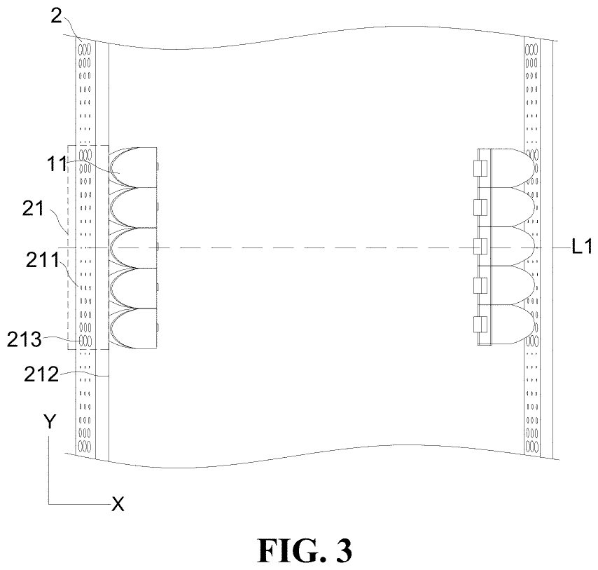

Referring to FIG. 3, the plane lens 2 includes a first lens portion 1. A refractive index of the first lens portion 2 to the electromagnetic waves gradually decreases from a middle to both sides in the first direction, so that the beam forming of the electromagnetic waves in the first direction can be achieved with aid of the first lens portion 2.

Optionally, when the electromagnetic wave emitted by the array antenna 1 radiates to the plane lens 2, a transmission path of the electromagnetic wave emitted by the array antenna 1 to the center of the plane lens 2 is short and a transmission path to the edge of the plane lens 2 is long, and the phase of the electromagnetic wave varies as the transmission path varies. As a result, the electromagnetic waves reaching the plane lens 2 gradually increase in phase from the center to the edge of the plane lens 2, and thus the electromagnetic waves reaching the plane lens 2 have a large phase difference, which causes a divergence of the electromagnetic waves and an increase in the electromagnetic wave gain.

The refractive index of the first lens portion 21 to the electromagnetic waves gradually decreases from the middle to both sides in the first direction. Since the greater the refractive index of the first lens portion 21 to the electromagnetic wave, the greater the amount of phase compensation of the first lens portion 21 to the electromagnetic wave, the phase compensation of the first lens portion 21 to the electromagnetic wave gradually decreases from the middle to both sides. Optionally, a part of the first lens portion 21 with a large refractive index can bring phase compensation to the electromagnetic wave reaching the center of the plane lens 2, and a part of the first lens portion 21 with a small refractive index can bring phase compensation to the electromagnetic wave reaching the edge of the plane lens 2. The electromagnetic wave radiated out through the plane lens 2 have the same phase as a result of different phase compensation of the plane lens 2, such that a beam with good beam pointing can be formed, the electromagnetic wave energy is concentrated, and the antenna gain is increased.

It should be noted that, the refractive index of the first lens portion 21 to the electromagnetic wave gradually varies in the first direction in a manner including, but not limited to, monotonous increasing, monotonic decreasing, and periodic increasing, etc. In periodic increasing, the refractive index jumps into a smaller value once increasing to a certain value, and then gradually increases again. The refractive index of the first lens portion 21 to the electromagnetic wave is not limited herein, as long as the first lens portion 21 can bring phase compensation to the electromagnetic wave to increase the electromagnetic wave energy and the gain.

Referring to FIG. 3, an orthographic projection of the first lens portion 21 on a plane of the array antenna 1 covers at least two antenna elements 11, so that beam scanning of electromagnetic waves emitted/received by at least two antenna elements 11 can be achieved with the first lens portion 21.

Optionally, at least two antenna elements 11 face the first lens portion 21, so that the electromagnetic waves emitted/received by the at least two antenna elements 11 can form multiple beams with different beam pointing after passing through the first lens portion 21, thereby facilitating realization of the beam scanning of the lens antenna module 10.

Further, referring to FIGS. 2 and 3, the first lens portion 21 has a normal line L1 passing through a focal point of the first lens portion 21. One antenna element 11 is located on the normal line L1. At least one antenna element 11 deviates from the normal line L1.

Optionally, referring to FIG. 2 and FIG. 3, the normal line L1 extends in the X-axis direction. When the first lens portion 21 is located at the center of the plane lens 2, the normal line L1 also acts as a normal line of the plane lens 2. A central axis of one antenna element 11 is collinear with the normal line L1, so that the electromagnetic waves emitted/received by the one antenna element 11 form a beam directed in a direction of the normal line L2 (i.e., the X-axis direction) after passing through the plane lens 2. Further, the antenna element 11 may be located at the focal point of the first lens portion 21.

Referring to FIG. 2 and FIG. 3, one or more antenna elements 11 deviate from the normal line L1 of the plane lens 2. Optionally, multiple antenna elements 11 are sequentially away from the normal line L1 of the plane lens 2 in the first direction, so that the electromagnetic waves emitted/received by the multiple antenna elements 11, after passing through the plane lens 2, form beams with beam pointing gradually deviated from the normal line L1. Further, the multiple antenna elements 11 are symmetrically distributed at two opposite sides of the normal line L1 to emit multiple beams with beam pointing gradually deviated from the normal line L1 to both sides, so as to improve the spatial coverage of the beams. In other implementations, in order to make beam pointing to gradually diverge from the normal line L1 to both sides, the multiple antenna elements 11 may be non-linearly arranged, the multiple antenna elements 11 are gradually away from the normal line L1 in the first direction and away from the first lens portion 21 in the normal line L1 direction.

The refractive index of the first lens portion 21 to the electromagnetic waves gradually decreases from the middle to both sides in the first direction, and implementations thereof include but are not limited to the following.

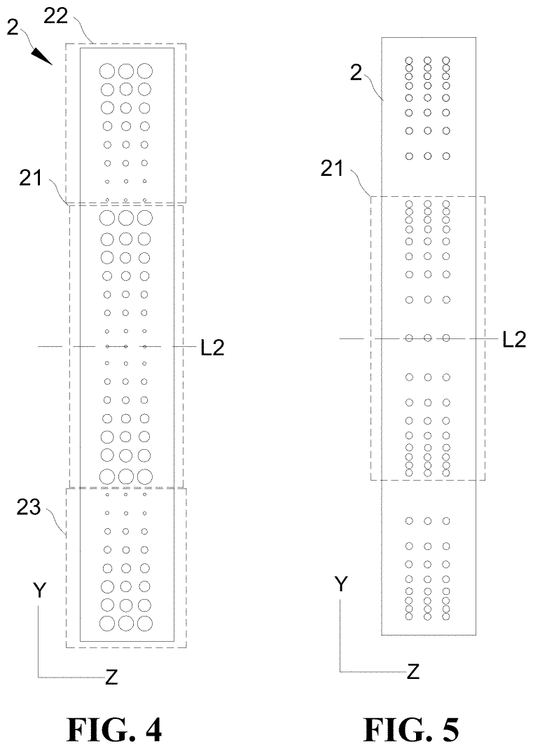

Referring to FIGS. 3 and 4, the first lens portion 21 has a first surface 211 and a second surface 212 opposite to the first surface 211, and defines multiple through holes 213 which are arranged in an array and penetrate the first surface 211 and the second surface 212. The first surface 211 faces the multiple antenna elements 11. The multiple through holes 213 gradually increase in aperture (i.e., diameter) from the middle to both sides in the first direction (i.e., the Y-axis direction).

Optionally, referring to FIG. 4, an equivalent dielectric constant of the plane lens 2 can be changed by changing the aperture of the through hole 213 in the plane lens 2. The through holes 213 sequentially increase in aperture from the middle to both sides in the first direction, and thus the equivalent dielectric constant of the plane lens 2 sequentially decreases from the middle to both sides. According to a correspondence between a dielectric constant of a medium and a refractive index of the medium to electromagnetic waves, the refractive index of the plane lens 2 to the electromagnetic waves sequentially decreases from the middle to both sides. It can be understood that, the through holes 213 can sequentially increase in aperture from the middle to both sides in the first direction, the term “middle” may refer to the geometric center of the first lens portion 21, or a central axis L2 extending in the Z-axis direction and passing through the geometric center of the first lens portion 21, or a position deviated from the geometric center of the first lens portion 21. In this implementation, the term “middle” may refer to the central axis L2 passing through the geometric center of the first lens portion 21.

Referring to FIG. 4, the through holes 213 sequentially increase in aperture from the middle to both sides in the first direction, so that the phase compensation of the plane lens 2 to the electromagnetic wave gradually decreases from the central axis L2 or the vicinity of the central axis L2 to both sides of the plane lens 2 in the first direction, to compensate the phase of the electromagnetic wave emitted by the array antenna 1. As such, the electromagnetic waves radiated out through the plane lens 2 have the same phase, and beams with good beam pointing can be formed, which achieves energy concentration of electromagnetic waves and increases the antenna gain. In addition, the plane lens 2 prepared in this implementation can have a gradually varied refractive index to the electromagnetic waves by adjusting spaces among the through holes 213, so that the refractive index can be adjusted in a large range and the refractive index of the first lens portion 21 at different positions can be flexibly set.

It should be noted that, depending on a design manner of the array antenna 1 and a dielectric substance selected for the first lens portion 21, the through holes 213 may also monotonically increase in diameter, or periodically increase in diameter, that is, the diameter jumps to a smaller value once increasing to a certain value, and then gradually increases again. A variation trend of the through holes 213 in diameter is not limited herein, as long as the first lens portion 21 can bring phase compensation to the electromagnetic wave, so as to increase the electromagnetic wave energy and the gain.

It can be understood that a shape of the through hole 213 is not limited herein, and the shape of the through hole 213 includes, but is not limited to, circle, square, triangle, and the like.

Referring to FIG. 5, the through holes 213 are arranged in a density which gradually increases from the middle to both sides in the first direction.

Optionally, the equivalent dielectric constant of the plane lens 2 can be changed by changing the density of the through holes 213 defined in the plane lens 2. The density of the through holes 213 increases from the middle to both sides in the first direction. As such, the equivalent dielectric constant value of the plane lens 2 sequentially decreases from the middle to both sides. According to the correspondence between a dielectric constant of a medium and a refractive index of the medium to the electromagnetic waves, the refractive index of the plane lens 2 to the electromagnetic waves sequentially decreases from the middle to both sides. In this implementation, the term “middle” can be explained with reference to the implementation illustrated in FIG. 4, which will not be repeated herein.

The phase compensation of the plane lens 2 to the electromagnetic wave gradually decreases from the central axis L2 or the vicinity of the central axis L2 to both sides of the plane lens 2 in the first direction by setting the density of the through holes 213 to sequentially increase from the middle to both sides in the first direction, to compensate the phase of the electromagnetic wave emitted by the array antenna 1. As such, the electromagnetic waves radiated out through the plane lens 2 have the same phase, and a beam with good beam pointing can be formed, which achieves the energy concentration of electromagnetic waves and increases the antenna gain. In addition, the plane lens 2 in this implementation can be prepared in a simple process, which only needs to set one single size for the through holes 213 and then adjusts the spaces among the through holes 213 to obtain the gradually varied refractive index of the plane lens 2 to the electromagnetic wave.

Referring to FIG. 4, the multiple through holes 213 gradually increase in aperture from the middle to both sides in the first direction, and the through holes 213 are arranged in a density which gradually increases from the middle to both sides in the first direction.

In this implementation, for a principle that the refractive index of the first lens portion 21 to the electromagnetic wave gradually decreases from the middle to both sides in the first direction, reference can be made to the implementations illustrated in FIGS. 4 and 5, which will not be repeated herein. In this implementation, the phase compensation of the plane lens 2 to the electromagnetic wave gradually decreases from the central axis L2 or the vicinity of the central axis L2 to both sides of the plane lens 2 in the first direction, to compensate the phase of the electromagnetic wave emitted by the array antenna 1. As such, the electromagnetic waves radiated out through the plane lens 2 have the same phase, a beam with good beam pointing can be formed, which achieves the energy concentration of electromagnetic waves and increases the antenna gain. In addition, in this implementation, two different adjustment manners, that is, adjusting the through holes 213 in aperture and adjusting the spaces among the through holes 213, are provided to adjust the refractive index of the first lens portion 21 to the electromagnetic wave. In practice, the two adjustment manners can be flexibly selected according to actual needs to improve the design flexibility of the plane lens 2.

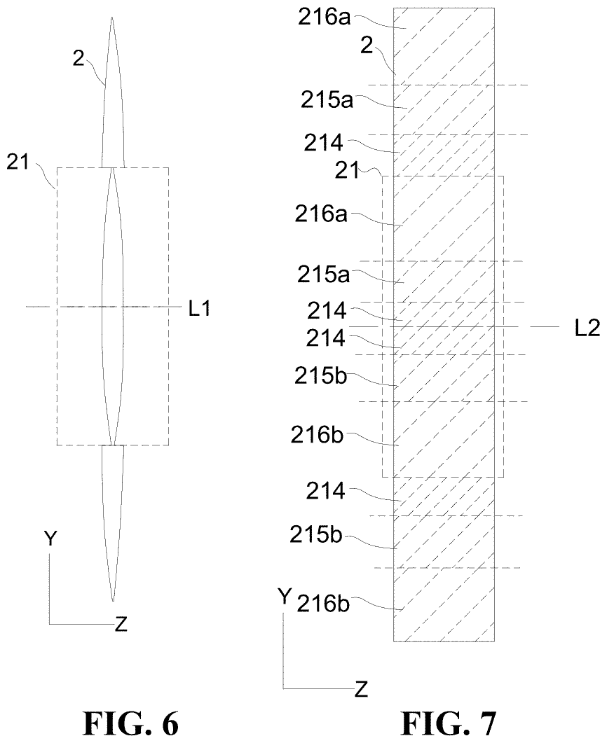

Referring to FIG. 6, the first lens portion 21 has a thickness which gradually increases from the middle to both sides in the first direction. The thickness is in a direction from the first surface 211 to the second surface 212. In other words, the thickness of the first lens portion 21 is a size of the first lens portion 21 in the Z-axis direction.

Optionally, the equivalent dielectric constant of plane lens 2 can be changed by changing the thickness of plane lens 2. The thickness of the plane lens 2 sequentially increases from the middle to both sides in the first direction, and in this case, the equivalent dielectric constant of the plane lens 2 decreases from the middle to both sides. According to the correspondence between a dielectric constant of a medium and a refractive index of the medium to the electromagnetic waves, the refractive index of the plane lens 2 to the electromagnetic waves sequentially decreases from the middle to both sides. In this implementation, the term “middle” can be explained with reference to the implementation illustrated in FIG. 4, which will not be repeated herein.

The thickness of the plane lens 2 sequentially increases in the first direction from the middle to both sides in any of the following manners: the first surface 211 of the plane lens 2 is a concave arc surface, and the second surface 212 is a planar surface; the second surface 212 of the plane lens 2 is a concave arc surface, and the first surface 211 is a planar surface; the first surface 211 and the second surface 212 of the plane lens 2 are both concave arc surfaces.

By setting the thickness of the plane lens 2 to sequentially increase in the first direction from the middle to both sides, the phase compensation of the plane lens 2 to the electromagnetic wave gradually decreases from the central axis L2 or the vicinity of the central axis L2 to both sides of the plane lens 2 in the first direction, so as to compensate the phase of the electromagnetic wave emitted by the array antenna 1. In this way, the electromagnetic waves radiated out through the plane lens 2 have the same phase, and a beam with good beam pointing can be obtained, which achieves the energy concentration of electromagnetic waves and increases the antenna gain. In addition, the plane lens 2 can be prepared in a simple process where no punching is needed, and the gradually varied refractive index of the plane lens 2 to the electromagnetic waves can be achieved by adjusting the thickness of the plane lens 2.

Fourth Implementation

Referring to FIG. 7, the first lens portion 21 is made of multiple materials with different refractive indexes.

Optionally, the first lens portion 21 is made of multiple materials with different refractive indexes to form a lens portion whose refractive index gradually decreases from the middle to both sides.

As an example, the first lens portion 21 includes a first segment 216a, a second segment 215a, and a third segment 214, a fourth segment 215b, and a fifth segment 216b that are sequentially arranged and integrally connected in the first direction. The first segment 216a, the second segment 215a, and the third segment 214 are each made of a different material. The fourth segment 215b and the second segment 215a are symmetrically arranged on both sides of the third segment 214. The fourth segment 215b is made of the same material as the second segment 215a. The fifth segment 216b and the first segment 216a are symmetrically arranged on both sides of the third segment 214. The fifth segment 216b is made of the same material as the first segment 216a. A refractive index of the first segment 216a to the electromagnetic waves is less than that of the second segment 215a, and a refractive index of the second segment 215a to the electromagnetic waves is less than that of the third segment 214. A refractive index of the fourth segment 215b to the electromagnetic waves is less than that of the third segment 214. A refractive index of the fifth segment 216b to the electromagnetic waves is less than that of the fourth segment 215b. Adjacent segments are merged with each other, so that the refractive index of the merged region is gradient.

By setting the plane lens 2 made of multiple materials with different refractive indexes to be a lens whose refractive index gradually decreases from the middle to both sides, the phase compensation of the plane lens 2 to the electromagnetic wave gradually decreases from the central axis L2 or the vicinity of the central axis L2 to both sides of the plane lens 2 in the first direction, so as to compensate the phase of the electromagnetic wave emitted by the array antenna 1. As such, the electromagnetic waves radiated out through the plane lens 2 have the same phase, and a beam with good beam pointing can be obtained, which achieves the energy concentration of electromagnetic waves and increases the antenna gain. In addition, the plane lens 2 can be prepared in a simple process where no punching is needed, and the plane lens 2 has a uniform thickness, which can reduce the thickness of the plane lens 2 and facilitate the application of the lens antenna module 10 to the electronic device 100 with limited internal space such as a mobile phone.

It should be noted that the above implementations can be combined with each other such that the refractive index of the first lens portion 21 to electromagnetic waves gradually decreases from the middle to both sides in the first direction.

Referring to FIGS. 3 and 4, the plane lens 2 further includes a second lens portion 22 and a third lens portion 23 which are connected to two opposite sides of the first lens portion 21 in the first direction. A refractive index of the second lens portion 22 to the electromagnetic waves gradually decreases in the first direction. A refractive index of the third lens portion 23 to the electromagnetic waves gradually increases in the first direction. The first direction is a direction from the first lens portion 21 to the second lens portion 22. Specifically, the refractive index of the second lens portion 22 to the electromagnetic waves gradually decreases from a preset refractive index in a direction away from the first lens portion 21. The refractive index of the third lens portion 23 to the electromagnetic waves gradually decreases from a preset refractive index in the direction away from the first lens portion 21. Optionally, the preset refractive index may be the refractive index of the first lens portion 21 at the central axis L2.

For example, in a case that a phase difference between the electromagnetic waves emitted by the array antenna 1 is greater than the maximum amount of phase compensation of the first lens portion 21, by providing the second lens portion 22 and the third lens portion 23 on the two opposite sides of the first lens portion 21, the second lens portion 22 and the third lens portion 23 can compensate phases of the electromagnetic waves emitted by the array antenna 1, and an electromagnetic wave subjected to the phase compensation of the second lens portion 22 or the third lens portion 23 is superimposed with an electromagnetic wave subjected to the phase compensation of the first lens portion 21, so as to achieve beamforming in the first direction to form an electromagnetic wave beam.

Referring to FIG. 3 and FIG. 4, the refractive index of the second lens portion 22 gradually decreases in a direction away from the first lens portion 21, and implementations include but are not limited to the following. The second lens portion 22 defines multiple through-holes which are arranged in an array and gradually increases in aperture in a direction away from the first lens portion 21; or the second lens portion 22 defines multiple through-holes which are arranged in an array and gradually increases in arrangement density in the direction away from the first lens portion 21; or the second lens portion 22 defines multiple through-holes which are arranged in an array and gradually increase in aperture and arrangement density in the direction away from the first lens portion 21. Alternatively, a thickness of the second lens portion 22 in the Z-axis direction gradually decreases in a direction away from the first lens portion 21; or the second lens portion 22 is made of multiple materials whose refractive indexes gradually decrease in a direction away from the first lens portion 21.

It can be understood that, for a principle of adjusting the refractive index of the second lens portion 22 in the above implementations, reference can be made to the principle of adjusting the refractive index of the first lens portion 21, which will not be repeated herein.

Referring to FIG. 3 and FIG. 4, a refractive index of the third lens portion 23 gradually decreases in a direction away from the first lens portion 21, and the implementations can refer to the second lens portion 22, which will not be repeated herein.

Referring to FIG. 4, the first lens portion 21 has a central axis L2 perpendicular to the first direction. The first lens portion 21 is symmetric about the central axis L2. The second lens portion 22 and the third lens portion 23 are symmetrically arranged about the central axis L2.

Optionally, referring to FIG. 3 and FIG. 4, the central axis L2 extends in the Z-axis direction. The central axis L2 of the first lens portion 21 also acts as the central axis L2 of the plane lens 2. A geometric center of the array antenna 1 may be located on the normal line L1 extending in the X-axis direction of the plane lens 2. By setting the first lens portion 21 to be symmetrical about the central axis L2 and setting the second lens portion 22 and the third lens portion 23 to be symmetrically arranged about the central axis L2, the phase compensations for the electromagnetic waves emitted/received by the array antenna 1 are symmetrical about the normal line L1, so that the beam radiated out from the plane lens 2 has beam pointing parallel to the normal line L1, that is, the beam radiated out from the plane lens 2 is parallel to the plane lens 2.

It should be noted that in this implementation, only one manner of refractive index gradient of each of the second lens portion 22 and the third lens portion 23 is given, but the manner of refractive index gradient of each of the second lens portion 22 and the third lens portion 23 is not limited herein. The manner of refractive index gradient of each of the second lens portion 22 and the third lens portion 23 can be adjusted according to actual needs. For example, the refractive index of each of the second lens portion 22 and the third lens portion 23 may gradually increases in the direction away from the first lens portion 21. Alternatively, a gradient trend of the refractive index of each of the second lens portion 22 and the third lens portion 23 may be the same as that of the refractive index of the first lens portion 21.

Referring to FIG. 3 and FIG. 4, the refractive index of the plane lens 2 to the electromagnetic waves is constant in a second direction. The second direction is perpendicular to the first direction. In an implementation, the refractive index of the plane lens 2 to the electromagnetic waves is constant in the width direction.

Optionally, the second direction is the Z-axis direction. When the electromagnetic waves emitted by the array antenna 1 are beam-formed in the second direction to form beams, the plane lens 2 has the same refractive index to the electromagnetic waves in the second direction, so that the plane lens 2 will not affect beams emitted by the array antenna 1 in the second direction but converges the beams emitted by the array antenna 1 in the first direction, which can further increase the beam gain.

Referring to FIG. 3 and FIG. 4, the refractive index of the plane lens 2 to the electromagnetic waves in the second direction can be achieved in, but not limited to, the following manners. The plane lens 2 defines multiple through holes 213 arranged in an array, the through holes 213 have the same aperture in the second direction, and each two adjacent through holes 213 are spaced apart at the same distance in the second direction.

In other implementations, when the electromagnetic waves emitted by the array antenna 1 diverge in the second direction, the refractive index of the plane lens 2 to the electromagnetic waves in the second direction may gradually decreases from the middle to both sides. The refractive index of the plane lens 2 to the electromagnetic wave can refer to the implementations where the first lens portion 21 has the reflective index to the electromagnetic waves, which will not be repeated herein. With the above processes, the beam forming of the electromagnetic wave in the second direction can be achieved with aid of the plane lens 2, which increases the antenna gain.

Referring to FIG. 2 and FIG. 3, the multiple antenna elements 11 are arranged in the first direction, so that the multiple electromagnetic waves emitted by the multiple antenna elements 11 are radiated to different positions on the plane lens 2 in the first direction. The electromagnetic waves emitted/received by the multiple antenna elements 11 form multiple beams with different beam pointing after passing through the plane lens 2.

Further, the first lens portion 21 has a normal line L1 passing through the focal point of the first lens portion 21. The multiple antenna elements 11 include the first antenna element 11 and two second antenna elements 11 disposed on two opposite sides of the first antenna element 11. The first antenna element 11 is located on the normal line L1. The two second antenna elements 11 deviate from the normal line L1. The electromagnetic waves emitted/received by the first antenna element 11 after passing through the plane lens 2 form a beam with a beam pointing different from a beam formed by the electromagnetic waves emitted/received by the two second antenna elements 11 after passing through the plane lens 2.

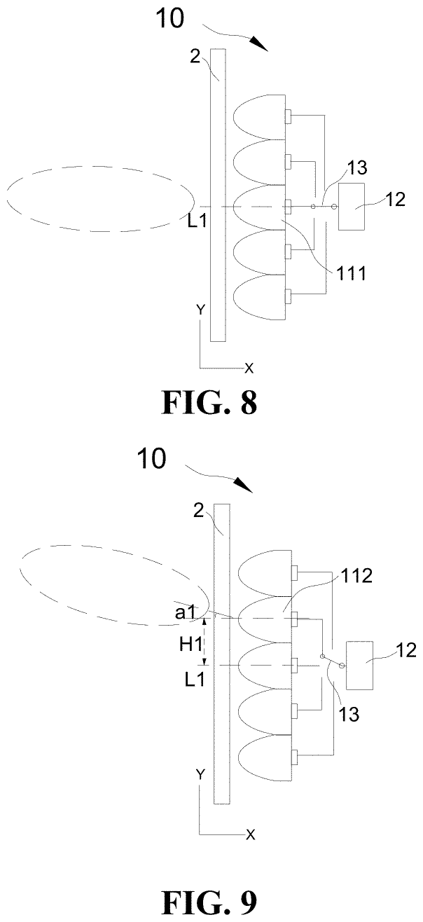

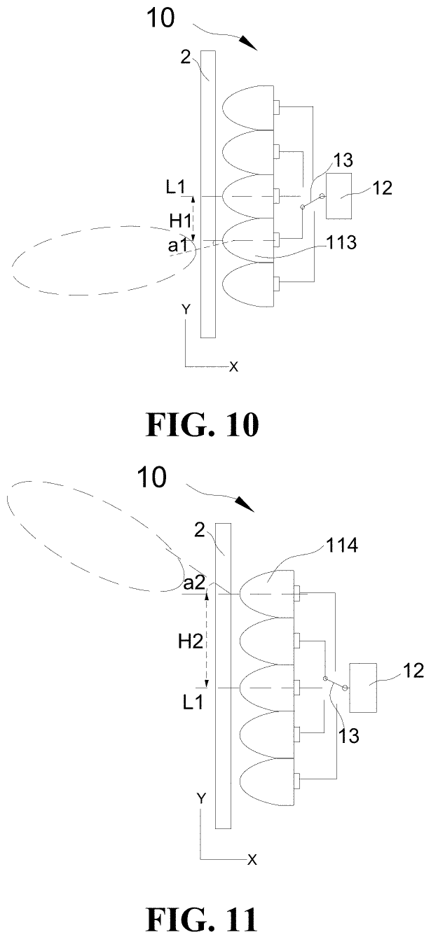

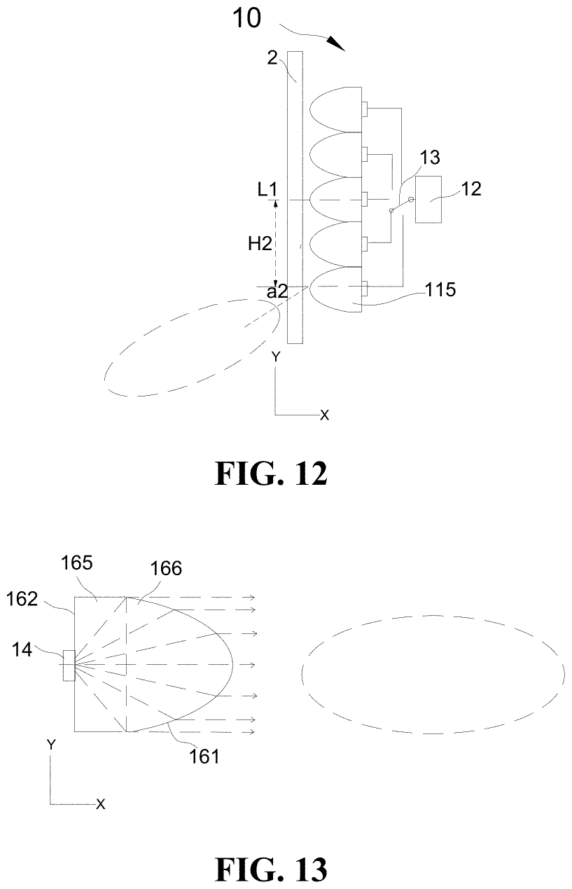

For example, referring to FIGS. 8 to 12, the focal point of the plane lens 2 is located on the normal line L1 of the plane lens 2. The multiple antenna elements 11 include five antenna elements 11, and the five antenna elements 11 are each located at a different position relative to the plane lens 2. For example, the first antenna element 111 is located on the normal line L1 of the plane lens 2. The second antenna element 112 and the third antenna element 113 are symmetrically distributed about the normal line L1 of the plane lens 2. The fourth antenna element 114 is located on a side of the second antenna element 112, the fifth antenna element 115 is located on a side of the third antenna element 113, and the fourth antenna element 114 and the fifth antenna element 115 are symmetrically distributed about the normal line L1 of the plane lens 2. Referring to FIG. 8, an electromagnetic wave emitted/received by the first antenna element 111 radiates out along the normal line L1 after passing through the plane lens 2. Referring to FIG. 9, an electromagnetic wave emitted/received by the second antenna element 112 deviates clockwise from the normal line L1 by a first angle a1 after passing through the plane lens 2. Referring to FIG. 10, an electromagnetic wave emitted/received by the third antenna element 113 deviates counterclockwise from the normal line L1 by the first angle a1 after passing through the plane lens 2. Referring to FIG. 11, an electromagnetic wave emitted/received by the fourth antenna element 114 deviates clockwise from the normal line L1 by a second angle a2 after passing through the plane lens 2. Referring to FIG. 12, an electromagnetic wave emitted/received by the fifth antenna element 115 deviates counterclockwise from the normal line L1 by the second angle a2 after passing through the plane lens 2. The second angle a2 is greater than the first angle a1. For example, the first angle a1 may range from 15° to 55°, and the second angle a2 may range from 50° to 90°.

Different antenna elements 11 are located at different positions relative to the plane lens 2, so that multiple beams with different beam pointing are formed after refraction of the plane lens 2. The plane lens 2 achieves beamforming, as such, beam energy can be increased, that is, the antenna gain can be increased. The multiple antenna elements 11 are controlled in transmission/reception through certain rules to achieve a high-gain beam scanning.

Referring to FIG. 8, the array antenna 1 further includes an RF transceiver chip 12 and a transfer switch 13. The RF transceiver chip 12 is configured to provide an excitation signal for the antenna element 11. The transfer switch 13 is electrically connected between the RF transceiver chip 12 and the multiple antenna elements 11. The transfer switch 13 is configured to switch the antenna element 11 connected with the RF transceiver chip 12, so that the electromagnetic waves emitted/received by the multiple antenna elements 11 can perform bean scanning in the first direction through the plane lens 2.

In one possible implementation, according to position information of a receiving device (such as a base station, other mobile devices, etc.), the RF transceiver chip 12 can control the transfer switch 13 to conduct the antenna element 11 corresponding to the position information, and provide an excitation signal for the antenna element 11 corresponding to the position information.

For example, when the receiving device (such as a base station, other mobile devices, etc.) deviates counterclockwise from the normal line L1 of the plane lens 2 by an angle of 30°, the RF transceiver chip 12 controls the transfer switch 13 to conduct the second antenna element 11, electromagnetic waves emitted/received by the second antenna element 11 pass through the plane lens 2 and then form a beam that deviates counterclockwise from the normal line L1 of the plane lens 2 by an angle of 15°˜55°, and beam pointing of the beam corresponds to the position information of the receiving device (such as a base station, other mobile devices, etc.), thereby realizing efficient communication between the electronic device 100 and the receiving device. A direction of the electronic device 100 will vary with movement of a user. When the receiving device (such as a base station, other mobile devices, etc.) deviates clockwise from the normal line L1 of the plane lens 2 by an angle of 60°, the RF transceiver chip 12 controls the transfer switch 13 to conduct the fifth antenna element 11, electromagnetic waves emitted/received by the fifth antenna element 11 pass through the plane lens 2 and then form a beam that deviates counterclockwise from the normal line L1 of the plane lens 2 by an angle of 50°˜90°, and beam pointing of the beam corresponds to the position information of the receiving device (such as a base station, other mobile devices, etc.), thereby realizing efficient communication between the electronic device 100 and the receiving device.

The beam pointing of the beam emitted/received by the lens antenna module 10 can be adjusted by switching the transfer switch 13, so that the lens antenna module 10 can emit/receive electromagnetic wave beams directionally, and the beam pointing of the beam emitted/received by the lens antenna module 10 can be adjusted according to the movement and rotation of the user, which can maintain good signal transmission between the lens antenna module 10 and the receiving device and improve the communication quality of the electronic device 100. Compared with the phased array antenna, the lens antenna module 10 in this implementation can achieve beam scanning with the transfer switch 13 without the need of phase shifters or attenuators, which can significantly reduce the cost.

It should be noted that the number of the antenna elements 11 is not limited herein. The multiple antenna elements 11 are located corresponding to different positions on the plane lens 2, so that the antenna elements 11 each have a different beam pointing range. The beam pointing ranges of different antenna elements 11 can overlap. By reasonably setting the number of the antenna elements 11, the beam pointing ranges of different antenna elements 11 can be superimposed to cover transmission/reception of the electromagnetic wave signals at one side. For example, a signal coverage angle of the electromagnetic waves emitted/received by the lens antenna module 10 is greater than 180 degrees.

Further, when the lens antenna module 10 is applied to a mobile phone, each of two sides of the mobile phone can be provided with the lens antenna module 10, and the two lens antenna modules 10 are arranged opposite to each other. In this way, the signal coverage angles of the two lens antenna modules 10 are superimposed to reach a coverage of 360 degrees, so that the mobile phone can transmit and receive antenna signals omni-directionally.

It can be understood that each of four sides of the mobile phone can be provided with the lens antenna module 10. In this way, signal coverage angles of the four lens antenna modules 10 can be superimposed to reach a coverage of 360 degrees, so that the mobile phone can transmit and receive antenna signals omni-directionally.

Referring to FIG. 2, the antenna element 11 is a lens antenna. The array antenna 1 is a lens array antenna 1 arranged in the Y-axis direction. Each lens antenna can converge electromagnetic waves, so that the electromagnetic wave signals emitted/received by the lens antenna have a large gain.

In one implementation, referring to FIG. 2 and FIGS. 8 to 12, when the multiple lens antennas all have the same structure, the multiple lens antennas face the first surface 211 of the plane lens 2 in the Y-axis direction. In an example, the multiple lens antennas include a first lens antenna, a second lens antenna, a third lens antenna, a fourth lens antenna, and a fifth lens antenna. The first lens antenna acts as the first antenna element 111. The second lens antenna acts as the second antenna element 112. The third lens antenna acts as the third antenna element 113. The fourth lens antenna acts as the fourth antenna element 114. The fifth lens antenna acts as the fifth antenna element 115. The first lens antenna is located on the normal line L1 of the plane lens 2. The second antenna and the third lens antenna are respectively located at two opposite sides of the normal line L1. The fourth lens antenna is located on a side of the second lens antenna and the fifth lens antenna is located on a side of the third lens antenna away from the second lens antenna. The above five lens antennas each emit a beam along the normal line L1, and these beams are refracted by the plane lens 2 to form multiple beams which diverge in different directions. Optionally, the first lens antenna is located on the normal line L1 passing through the focal point of the plane lens 2. Further, the first lens antenna may be located at the focal point of the plane lens 2. Referring to FIG. 2 and FIG. 8, the electromagnetic waves emitted/received by the first lens antenna pass through the plane lens 2 to radiate out a first beam along the normal line L1. Referring to FIG. 2 and FIG. 9, the second lens antenna deviates from the normal line L1 by a first distance H1. A second beam emitted by the second lens antenna, after passing through the plane lens 2, radiates out toward a side where the second lens antenna is located in a direction deviated from the normal line L1 by a first angle a1. The third lens antenna and the second lens antenna are symmetrically arranged about the normal line L1. Referring to FIG. 2 and FIG. 10, the third lens antenna deviates from the normal line L1 by the first distance H1. A third beam emitted by the third lens antenna, after passing through the plane lens 2, radiates out toward a side where the third lens antenna is located in a direction deviated from the normal line L1 by the first angle a1. Referring to FIG. 2 and FIG. 11, the fourth lens antenna deviates from the normal line L1 by the second distance H2. A fourth beam emitted by the fourth lens antenna, after passing through the plane lens 2, radiates out toward a side where the fourth lens antenna is located in a direction deviated from the normal line L1 by the second angle a2. The second distance H2 is greater than the first distance H1, and the second angle a2 is greater than the first angle a1. Referring to FIG. 2 and FIG. 12, the fifth lens antenna and the fourth lens antenna are arranged symmetrically about the normal line L1. The fifth lens antenna deviates from the normal line L1 by a second distance H2. A fifth beam emitted by the fifth lens antenna, after passing through the plane lens 2, radiates out toward a side where the fifth lens antenna is located in a direction deviated from the normal line L1 by the second angle a2.

It can be understood that, as a distance of the lens antenna deviated from the normal line L1 increases, a deviation angle of a beam emitted by the lens antenna after passing through the plane lens 2 relative to the normal line L1 increases.

By arranging multiple different lens antennas to face the first surface 211 of the plane lens 2 in the Y-axis direction, the electromagnetic waves emitted by multiple different lens antennas form multiple parallel beams with high gains, and the multiple parallel beams are refracted by the plane lens 2 to form multiple beams with different angles. Ranges of adjacent beams can partially overlap with each other, the multiple beams with different angles are superimposed to form a beam space coverage of the lens antenna module 10. By adjusting the number of the lens antennas, the beam space coverage of the lens antenna module 10 is increased, so that the electronic device 100 has a higher gain and a larger space coverage.

In other implementations, the multiple lens antennas have different structures, so that electromagnetic waves emitted by the multiple different lens antennas form multiple divergent beams with high gains, and the multiple divergent beams are refracted by the plane lens 2 to form multiple beams with different angles. Ranges of adjacent beams can partially overlap with each other, and the multiple beams of different angles are superimposed to form the beam space coverage of the lens antenna module 10. By adjusting the number of lens antennas, the beam space coverage of the lens antenna module 10 is increased, so that the electronic device 100 has a higher gain and a larger space coverage.

In another implementation, the array antenna 1 may be a phased array antenna. By controlling different antenna elements 11 in the phased array antenna to emit/receive electromagnetic waves, these antenna elements 11 can emit/receive electromagnetic wave beams with different beam pointing to achieve beam scanning, and these multiple electromagnetic wave beams are converged in the first direction after passing through the plane lens 2, so that gains of the electromagnetic wave beams can be increased, and high-gain electromagnetic wave beam scanning can be achieved.

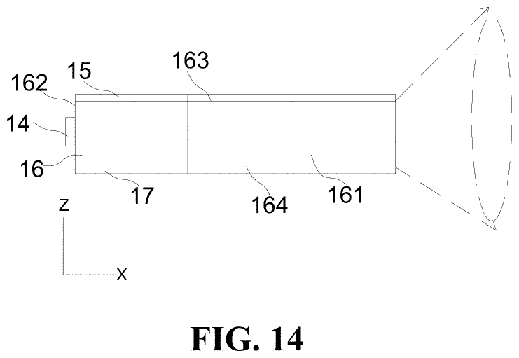

Optionally, referring to FIG. 13 and FIG. 14, the antenna element 11 includes a radiator 14 and further includes a first metal plate 15, a dielectric lens 16, and a second metal plate 17 which are sequentially stacked. The dielectric lens 16 has an arc surface 161 and a rectangular surface 162. The arc surface 161 is between the first metal plate 15 and the second metal plate 17. The rectangular surface 162 is opposite to the arc surface 161. The arc surface 161 faces the plane lens 2 and the radiator 14 is disposed on the rectangular surface 162. The radiator 14 is electrically connected to the transfer switch 13.

Optionally, referring to FIG. 2, the lens antenna module 10 includes multiple antenna elements 11. The multiple antenna elements 11 are arranged in a linear array, a two-dimensional array, or a three-dimensional array. In this implementation, for example, the multiple antenna elements 11 are arranged in a linear array in the Y-axis direction. In this implementation, the dielectric lens 16 is made of a material that has low loss, appropriate dielectric constant, and does not interfere with an electric field of the electromagnetic wave, such as a ceramic material, a polymer material, and the like. The polymer material can be selected from materials with excellent chemical stability, corrosion resistance, and long service life, such as polytetrafluoroethylene, epoxy resin, etc.

Referring to FIG. 14, the dielectric lens 16 has a top surface 163 and a bottom surface 164 opposite to the top surface 163. The first metal plate 15 is fixed on the top surface 163 of the dielectric lens 16, and the second metal plate 17 is fixed on the bottom surface 164 of the dielectric lens 16. The first metal plate 15 and the second metal plate 17 have the same shape as the top surface 163 and the bottom surface 164, respectively. The first metal plate 15 and the second metal plate 17 form a parallel metal plate waveguide, which is used to guide an electromagnetic wave signal emitted/received by the radiator 14 to propagate in the dielectric lens 16 between the first metal plate 15 and the second metal plate 17. The first metal plate 15 and the second metal plate 17 are each made of a material with good electrical conductivity, which includes but is not limited to gold, silver, copper, etc. The first metal plate 15 and the second metal plate 17 also play a role in protecting the dielectric lens 16. In other implementations, the first metal plate 15 and the second metal plate 17 may be replaced by metal thin films to reduce the thickness and weight of the antenna element 11.

Referring to FIG. 13, the dielectric lens 16 includes a semi-elliptical portion 165 and a rectangular portion 166 connected with the semi-elliptical portion 165. The semi-elliptical portion 165 is semi-elliptical. The rectangular portion 166 is in a shape of square block. A rectangular surface of the semi-elliptical portion 165 is coplanar with a side surface of the rectangular portion 166. For example, the semi-elliptical portion 165 and the rectangular portion 166 are integrally formed. From a top view, a short axis of the semi-elliptical portion 165 is connected to and has the same size as a long side of the rectangular portion 166. A thickness of the semi-elliptical portion 165 (in a direction in which the first metal plate 15, the dielectric lens 16, and the second metal plate 17 are stacked) is the same as the thickness of the rectangular portion 166. An arc extension length defining the arc surface 161 of the semi-elliptical portion 165 is equal to the aperture of the dielectric lens 16.

The dielectric lens 16 adopts a semi-elliptical cylindrical lens. Compared with a spherical lens, the semi-elliptical cylindrical lens has a smaller volume and is easy to be integrated into the electronic device 100 such as a mobile phone. Moreover, the semi-elliptic cylindrical lens is easy to process and low is cost. The rectangular surface 162 of the semi-elliptic cylindrical lens can be integrated with a planar circuit, so that the radiator 14 can be arranged on the semi-elliptic cylindrical lens.

In an example, the arc surface 161 is an arc-shaped side surface of the semi-elliptical portion 165. The arc surface 161 connects the top surface 163 and the bottom surface 164. The arc surface 161 is a semi-elliptical cylindrical surface. The rectangular surface 162 is on the rectangular portion 166.

When the radiator 14 is located on the rectangular surface 162, the electromagnetic wave signal emitted/received by the radiator 14 passes through the rectangular surface 162 to enter and propagate in the dielectric lens 16, and then radiates out through the arc surface 161. During radiation, the electromagnetic wave signal will be refracted on the arc surface 161, and a propagation direction of the electromagnetic wave signal is changed. According to the law of refraction, since the refractive index of the dielectric lens 16 is greater than and different from the refractive index of air, a refraction angle of the electromagnetic wave signal is less than an incident angle, which can reduce a transmission/reception range of the electromagnetic wave signal after radiating out from the arc surface 161, such that a beam with a better beam pointing can be formed. In other words, the dielectric lens 16 converges the electromagnetic wave signal in a short axis direction, so the energy of the electromagnetic wave signal is concentrated to form a well-directed beam to increase a gain of the electromagnetic wave signal.

It can be understood that the dielectric lens 16 has a converging effect on the electromagnetic wave in an extending direction of the long side of the rectangular surface 162, and the direction is the same as the thickness direction of the dielectric lens 16.

It should be noted that, during electromagnetic wave signal reception of the radiator 14, electromagnetic wave signals in space can be converged to the radiator 14 through the arc surface 161. Since an area of the arc surface 161 is larger than that of the radiator 14, the dielectric lens 16 can receive more electromagnetic wave signals in space and converge these electromagnetic wave signals to the radiator 14. With aid of this disclosure, energy of electromagnetic waves received by the radiator 14 can be increased and the communication quality of electronic device 100 can be improved.

In a possible implementation, a geometric center of the rectangular surface 162 is at a focal point of the semi-elliptical portion 165, and the radiator 14 is disposed at the focal point of the semi-elliptical portion 165, so that a spherical wave emitted/received by the radiator 14 passes through the dielectric lens 16, the first metal plate 15, and the second metal plate 17 to form a plane wave and then radiates out from the arc surface 161. The dielectric lens 16, the first metal plate 15, and the second metal plate 17 converge the electromagnetic waves in the short axis direction of the dielectric lens 16, so as to increase the electromagnetic wave gain. When the radiator 14 is disposed at the focal point of the dielectric lens 16, the electromagnetic wave signals emitted/received by the radiator 14 can efficiently radiate through the dielectric lens 16, which improves aperture efficiency of the dielectric lens 16. In addition, a size of the dielectric lens 16 is reduced as much as possible, which can reduce its space occupation in the electronic device 100, and facilitates the miniaturization of the electronic device 100. Of course, in other implementations, the radiator 14 may deviate from the focal point of the semi-elliptical portion 165.

The semi-elliptical portion 165 and the rectangular portion 166 of the dielectric lens 16 are not limited in size herein. In addition, by adjusting the long axis, the short axis, and the aperture of the semi-elliptical portion 165 of the dielectric lens 16 as well as the focal length of the dielectric lens 16, the semi-elliptical cylindrical lens antennas with different lens antenna gains and sizes can be easily designed. In this way, the size of the lens antenna module 10 can be reduced as much as possible, and the space occupation of the lens antenna module 10 in the electronic device 100 can be reduced, which is beneficial to the miniaturization of the electronic device 100. Since the semi-elliptical portion 165 can adjust the lens antenna gain by adjusting the long axis and the short axis, design freedom is improved, and it is convenient to be applied to different types of mobile phones.

It can be understood that the semi-elliptical portion 165 of the dielectric lens 16 can be replaced with a semi-cylindrical portion, and a semi-cylindrical lens antenna can be designed. Antenna elements 11 with different gains and sizes can be easily designed by adjusting the diameter of the semi-cylindrical lens.

It can be understood that the radiator 14 of the antenna element 11 is not limited herein. For example, the radiator 14 includes, but is not limited to, a planar antenna, such as a microstrip antenna, a slot antenna, and the like. In addition, the radiator 14 can also selected from antennas with different polarization directions, which can conveniently achieve a horizontal polarized antenna element 11, a vertical polarized antenna element 11, and a dual polarized antenna element 11.

It can be understood that due to low loss of the dielectric lens 16, the radiator 14 of the lens antenna module 10 can emit/receive antenna signals in the millimeter wave band, sub-millimeter band, and even terahertz wave band.

It can be understood that in this implementation, the semi-elliptic cylindrical lens of each antenna element 11 may have the same size. In other implementations, the semi-elliptic cylindrical lens of each antenna element 11 may have different sizes. In other words, the array antenna 1 may include semi-elliptic cylindrical lenses with different focal lengths. By linearly arranging multiple semi-elliptic cylindrical lenses, a one-dimensional semi-elliptic cylindrical lens antenna can be formed. The multiple radiators 14 can be in the same plane or in different planes. When the multiple radiators 14 are each disposed in a different plane, a scanning beam uniformity can be improved, that is, the electromagnetic wave beams emitted by the multiple radiators 14 have different beam pointing after passing through the dielectric lens 16.

In the disclosure, the multiple semi-elliptic cylindrical lenses and the plane lens 2 are arranged to form a master-slaver lens. The electromagnetic wave signals emitted/received by the multiple radiators 14 are converged by the semi-elliptical cylindrical lenses to form multiple high-gain beams. The multiple high-gain beams are refracted by the plane lens 2 to form multiple high-gain beams with different angles. By switching and activating different radiators 14 to emit/receive electromagnetic waves, high-gain beam scanning can be achieved after the beams emitted/received by different radiators 14 are converged by the plane lens 2. The lens antenna module 10 can be integrated to a side surface or a rear surface of the mobile phone (a display screen of the mobile phone is on a front surface of the mobile phone) to achieve millimeter wave communication of the mobile phone with high efficiency, high gain, and low-cost beam scanning.

One antenna element 11 is disposed at the focal point of the plane lens 2 and has a thickness in the first direction. After the electromagnetic waves emitted by the antenna element 11 are converged by the plane lens 2, a beam of the antenna element 11 in the thickness direction is converted into a narrow beam, while a beam width in the short axis direction remains unchanged. With aid of the through holes 213 which gradually vary in diameter in the first direction, the plane lens 2 of the disclosure achieves an electromagnetic wave convergence effect in the first direction, such that a beam scanned in the first direction is a narrow beam, and will not affect the beam in the Z-axis direction.

The multiple antenna elements 11 are linearly arranged in the first direction, and form a master-slave lens antenna together with the plane lens 2. A beam emitted/received by the antenna element 11 at the middle is converged by the plane lens 2 to direct in the normal direction of the plane lens 2, that is, an angle between beam pointing of the beam and the normal direction is 0°. The beams emitted/received by the antenna elements 11 at both sides have beam pointing with other angles. The farther the antenna element 11 away from the normal line L1 of the plane lens 2, the greater the angle of the beam pointing of the antenna element 11. Since the antenna array is left-right symmetrical, the beam scanning is left-right mirror-symmetrical.

The plane lens 2 and the semi-elliptical cylindrical lens can be both made of a high-dielectric constant material to reduce a size and weight of the master-slaver lens antenna.

The multiple antenna elements 11 are linearly arranged in the first direction in a manner which includes but is not limited to the following.

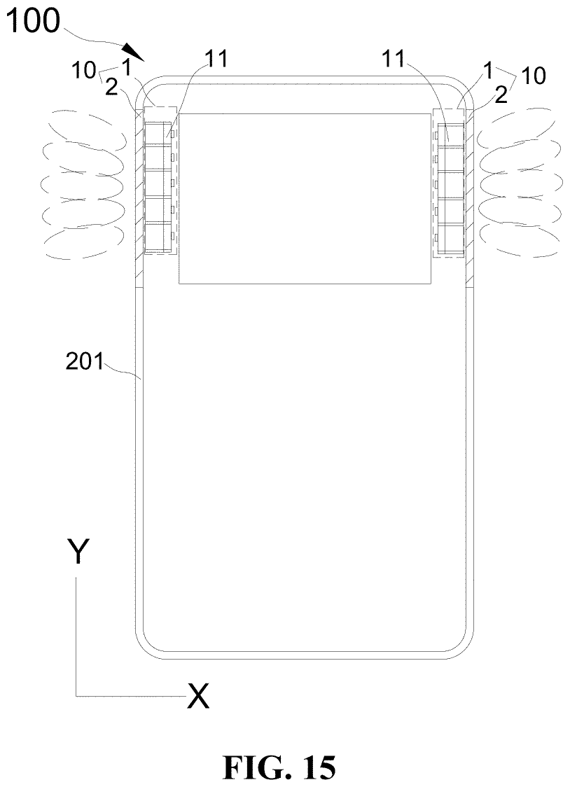

Referring to FIG. 15, in a possible implementation, the first metal plate 15, the dielectric lens 16, and the second metal plate 17 are arranged in the same direction as that in which the multiple antenna elements 11 are arranged.

Optionally, the first metal plate 15, the dielectric lens 16, and the second metal plate 17 are stacked in the first direction. When the lens antenna module 10 is applied to a mobile phone, in the semi-elliptical cylindrical lens antenna module 10, the first metal plate 15 is perpendicular to a battery cover of the mobile phone, and the first metal plates 15 of two adjacent semi-elliptic cylindrical lens antenna are parallel with each other, which is called a vertical array in the disclosure. As a result, the semi-elliptic cylindrical lens antenna has a wide beam in the first direction, such that a beam of the semi-elliptical cylindrical lens antenna has a larger irradiation area on the plane lens 2, which improves the aperture efficiency of the master-slave lens antenna.

In this implementation, two adjacent dielectric lenses 16 are spaced with a metal layer or a metal plate.

Referring to FIG. 2 and FIG. 13, in a possible implementation, the first metal plate 15, the dielectric lens 16, and the second metal plate 17 are sequentially arranged in a direction perpendicular to the first direction (i.e., the Z-axis direction), and the rectangular surface 162 has a long side extended in the first direction.

Optionally, the metal plate (which includes the first metal plate 15 and the second metal plate 17) of the semi-elliptic cylindrical lens antenna is parallel to the battery cover of the mobile phone, and the metal plates of two adjacent semi-elliptic cylindrical lens antenna are in the same plane, which is called a horizontal array in the disclosure. When the lens antenna module 10 is applied to a mobile phone, since the metal plate of the semi-elliptic cylindrical lens antenna is parallel to the battery cover of the mobile phone, it can be easily fixed on the battery cover of the mobile phone. At the same time, a beam width of the semi-elliptical cylindrical lens antenna in the first direction is controllable. An irradiation area of the beam of the semi-elliptical cylindrical lens antenna on the plane lens 2 can be adjusted by adjusting the long axis of the semi-elliptic cylindrical lens antenna, such that a better master-slave lens antenna can be designed.

In this implementation, the antenna element 11 is configured to emit/receive millimeter wave signals. When the lens antenna module 10 is applied to the electronic device 100 such as a mobile phone, it can achieve the millimeter wave communication of the mobile phone with high efficiency, high gain, and low-cost beam scanning.

Referring to FIG. 1, an electronic device 100 provided in the disclosure includes any of the lens antenna modules 10 described above.

Referring to FIG. 2, an electronic device 100 is further provided in the disclosure. The electronic device 100 includes a middle frame 201 and two millimeter-wave (mm-Wave) lens antenna modules (refer to the antenna module illustrated in FIG. 2) fixed to two opposite sides of the middle frame 201. The mm-Wave lens antenna module includes an mm-Wave array antenna (refer to the array antenna illustrated in FIG. 2) and a plane lens 2. The mm-Wave array antenna includes multiple mm-Wave antenna elements (refer to the antenna element illustrated in FIG. 2) arranged in an array and configured to emit/receive mm-Wave signals towards the plane lens 2. The plane lens 2 is fixed to the middle frame 201 and faces one side of the multiple mm-Wave antenna elements where the multiple mm-Wave antenna elements emit/receive the mm-Wave signals. The plane lens 2 is configured to refract the mm-Wave signals, and a refractive index of the plane lens to the mm-Wave signals is gradually varied. The plane lens 2 has a gradually varied refractive index to mm-Waves in the first direction, such that the beam forming and the beam scanning of the millimeter wave signals emitted/received by the multiple mm-Wave antenna elements in the first direction can be achieved, where the first direction is a long side direction of the middle frame 201. Optionally, when the multiple mm-Wave antenna elements are linearly arranged in one dimension, the first direction is an arrangement direction of the multiple mm-Wave antenna elements.

By setting the plane lens 2 to face the mm-Wave array antenna, when the mm-Waves emitted/received by the multiple antenna elements of the mm-Wave array antenna pass through the plane lens 2, because the refractive index of the plane lens 2 to the mm-Waves gradually varies in the first direction, the varied phase compensation provided to the mm-Waves by the plane lens in the first direction gradually varies. In this way, by controlling a gradient trend of the refractive index of the plane lens 2 to the mm-Waves in the first direction, the mm-Waves emitted/received by the multiple antenna elements can have the same phase in the first direction after passing through the plane lens 2, so that the plane lens 2 can achieve beamforming for the mm-Waves in the first direction. Further, by controlling different antenna elements 11 to emit/receive mm-Waves toward/from different positions on the plane lens 2, multiple mm-Wave beams with different directions can be formed, which is beneficial to achieving the beam scanning of the lens antenna module 10 and increasing the mm-Wave communication efficiency and gain of the electronic device 100.

Further, two mm-Wave lens antenna modules can be symmetrically arranged on two opposite sides of the electronic device 100.

In other implementations, the first direction may be a short side direction of the middle frame 201. The first direction may also be a thickness direction of the electronic device 100.

In other implementations, when the electronic device 100 is a mobile phone, the mm-Wave lens antenna module can also be fixed to the battery cover of the electronic device 100.

Referring to FIGS. 3 and 4, the plane lens 2 includes a first lens portion 21, and a second lens portion 22, and a third lens portion 23. The second lens portion 22 and the third lens portion 23 are connected to two opposite sides of the first lens portion 21. A refractive index of the first lens portion 21 to the mm-Wave signals gradually decreases from a middle to both sides in the first direction. A refractive index of the second lens portion 22 gradually decreases in the first direction. A refractive index of the third lens portion 23 gradually increases in the first direction.

Referring to FIG. 2, the multiple mm-Wave antenna elements are arranged in the first direction. The mm-Wave array antenna includes an RF transceiver chip 12 and a transfer switch 13. The RF transceiver chip 12 is configured to provide an excitation signal for the multiple mm-Wave antenna elements. The transfer switch 13 is electrically connected between the RF transceiver chip 12 and the multiple the mm-Wave antenna elements. The transfer switch 13 is configured to switch the mm-Wave antenna element that is connected with the RF transceiver chip 12, so that the mm-Wave signals emitted/received by the multiple mm-Wave antenna elements are capable of achieving scanning in the first direction with aid of the plane lens 2.

In an implementation, the mm-Wave array antenna includes an mm-Wave chip 12 and a transfer switch 13. The mm-Wave chip 12 is configured to provide an excitation signal for the multiple mm-Wave antenna elements. The transfer switch 13 is electrically connected between the mm-Wave chip 12 and the multiple mm-Wave antenna elements. The transfer switch 13 is configured to switch at least one antenna element connected with the mm-Wave chip 12 to another antenna element(s), so that scanning of the mm-Wave signals emitted/received by the multiple mm-Wave antenna elements can be achieved in the first direction with aid of the plane lens 2.

Beam pointing of the mm-Wave beam emitted/received by the mm-Wave beam lens antenna module can be adjusted by switching the transfer switch 13, so that the mm-Wave beam lens antenna module can emit/receive the mm-Wave beam directionally, and thus the direction of the mm-Wave beam emitted/received by the mm-Wave beam lens antenna module can be adjusted according to movement and rotation of the user, which can maintain good signal transmission between the mm-Wave beam lens antenna module and the receiving device and improve the communication quality of the electronic device 100. Compared with the phased array antenna, the mm-Wave beam lens antenna module in this implementation can achieve beam scanning with the transfer switch 13 without the need of phase shifters or attenuators, which can significantly reduce the cost.

The implementations of the disclosure are described in detail above, specific examples are used herein to describe the principle and implementation manners of the disclosure. The description of the above implementations is merely used to help understand the method and the core idea of the disclosure. Meanwhile, those skilled in the art may make modifications to the specific implementation manners and the application scope according to the idea of the disclosure. In summary, the contents of the specification should not be construed as limiting the disclosure.

What is claimed is:

1. A lens antenna module, comprising:
an array antenna, comprising a plurality of antenna elements arranged in an array, wherein the plurality of antenna elements are configured to emit/receive electromagnetic waves; and
a plane lens, facing the plurality of antenna elements and located at one side of the plurality of antenna elements where the electromagnetic waves are emitted/received, wherein the plane lens is configured to refract the electromagnetic waves, and a refractive index of the plane lens to the electromagnetic waves is gradually varied in a first direction.

2. The lens antenna module of claim 1, wherein:
the plane lens comprises a first lens portion, and a refractive index of the first lens portion to the electromagnetic waves gradually decreases from a middle to both sides in the first direction; and
the plurality of antenna elements are arranged in the first direction.

3. The lens antenna module of claim 2, wherein an orthographic projection of the first lens portion on a plane of the array antenna covers at least two antenna elements.

4. The lens antenna module of claim 2, wherein:
the first lens portion has a first surface and a second surface opposite to the first surface, and defines a plurality of through holes which are arranged in an array and penetrate the first surface and the second surface, wherein the first surface faces the plurality of antenna elements; and
the plurality of through holes gradually increase in aperture from the middle to both sides in the first direction; and/or the plurality of through holes are arranged in a density which gradually increases from the middle to both sides in the first direction.

5. The lens antenna module of claim 2, wherein:
the first lens portion has a first surface and a second surface opposite to the first surface, and the first surface faces the plurality of antenna elements; and
the first lens portion has a thickness which gradually increases from the middle to both sides in the first direction, and the thickness is in a direction from the first surface to the second surface.

6. The lens antenna module of claim 2, wherein:
the first lens portion comprises a first segment, a second segment, and a third segment that are sequentially arranged and connected in the first direction, and the first segment, the second segment, and the third segment are each made of a different material; and
a refractive index of the first segment to the electromagnetic waves is less than that of the second segment, and a refractive index of the second segment to the electromagnetic waves is less than that of the third segment.

7. The lens antenna module of claim 2, wherein:
the plane lens further comprises a second lens portion and a third lens portion which are arranged in the first direction and connected to two opposite sides of the first lens portion; and
a refractive index of the second lens portion to the electromagnetic waves gradually decreases in the first direction, a refractive index of the third lens portion to the electromagnetic waves gradually increases in the first direction, and the first direction is a direction from the first lens portion to the second lens portion.

8. The lens antenna module of claim 7, wherein the first lens portion has a central axis perpendicular to the first direction, the first lens portion is symmetric about the central axis, and the second lens portion and the third lens portion are symmetrically arranged about the central axis.

9. The lens antenna module of claim 2, wherein the refractive index of the plane lens to the electromagnetic waves is constant in a second direction, and the second direction is perpendicular to the first direction.

10. The lens antenna module of claim 9, wherein the first lens portion has a normal line passing through a focal point of the first lens portion, the plurality of antenna elements comprise a first antenna element and at least two second antenna elements symmetrically arranged on two opposite sides of the first antenna element, and the first antenna element is located on the normal line.

11. The lens antenna module of claim 10, wherein the array antenna further comprises a radio frequency (RF) transceiver chip and a transfer switch, wherein the RF transceiver chip is configured to provide an excitation signal for the plurality of antenna elements, the transfer switch is electrically connected between the RF transceiver chip and the plurality of antenna elements, and the transfer switch is configured to switch at least one antenna element that is connected with the RF transceiver chip.

12. The lens antenna module of claim 11, wherein:
the antenna element comprises a radiator, a first metal plate, a dielectric lens, and a second metal plate, wherein the first metal plate, the dielectric lens, and the second metal plate are sequentially stacked;
the dielectric lens has an arc surface and a rectangular surface, wherein the arc surface is between the first metal plate and the second metal plate, and the rectangular surface is opposite to the arc surface, the arc surface faces the plane lens and the radiator is disposed on the rectangular surface, and the radiator is electrically connected to the transfer switch.

13. The lens antenna module of claim 12, wherein the first metal plate, the dielectric lens, and the second metal plate are sequentially arranged in the first direction.

14. The lens antenna module of claim 12, wherein the first metal plate, the dielectric lens, and the second metal plate are sequentially arranged in a direction perpendicular to the first direction, and the rectangular surface has a long side extended in the first direction.

15. The lens antenna module of claim 12, wherein the dielectric lens comprises a semi-elliptical portion and a rectangular portion connected with the semi-elliptical portion, the arc surface is on the semi-elliptical portion, the rectangular surface is on the rectangular portion, and the radiator is located at a focal point of the dielectric lens.

16. The lens antenna module of claim 1, wherein the antenna element is configured to emit/receive millimeter wave signals, submillimeter wave signals, or terahertz wave signals.

17. An electronic device, comprising a middle frame and a lens antenna module fixed to the middle frame, wherein the lens antenna module comprises:
an array antenna, comprising a plurality of antenna elements arranged in an array, wherein the plurality of antenna elements are configured to emit/receive electromagnetic waves; and
a plane lens, facing the plurality of antenna elements and located at one side of the plurality of antenna elements where the electromagnetic waves are emitted/received, wherein the plane lens is configured to refract the electromagnetic waves, and a refractive index of the plane lens to the electromagnetic waves is gradually varied in a first direction.

18. An electronic device, comprising:
a middle frame; and
two millimeter-wave (mm-Wave) lens antenna modules fixed on two opposite sides of the middle frame, wherein the mm-Wave lens antenna module comprises an mm-Wave array antenna and a plane lens, the mm-Wave array antenna comprises a plurality of mm-Wave antenna elements arranged in an array and configured to emit/receive mm-Wave signals;
the plane lens is fixed to the middle frame and faces one side of the plurality of mm-Wave antenna elements where the plurality of mm-Wave antenna elements emit/receive the mm-Wave signals; and
the plane lens is configured to refract the mm-Wave signals, and a refractive index of the plane lens to the mm-Wave signals is gradually varied.

19. The electronic device of claim 18, wherein:
the plane lens comprises a first lens portion, and a second lens portion, and a third lens portion, wherein the second lens portion and the third lens portion are connected to two opposite sides of the first lens portion; and
a refractive index of the first lens portion to the mm-Wave signals gradually decreases from a middle to both sides in a first direction, a refractive index of the second lens portion gradually decreases in the first direction, a refractive index of the third lens portion gradually increases in the first direction, and the plurality of mm-Wave antenna elements are arranged in the first direction.

20. The electronic device of claim 19, wherein the mm-Wave array antenna comprises an mm-Wave chip configured to provide an excitation signal for the plurality of mm-Wave antenna elements and a transfer switch electrically connected between the mm-Wave chip and the plurality of mm-Wave antenna elements, the transfer switch is configured to switch at least one antenna element that is connected with the mm-Wave chip, so that scanning of the mm-Wave signals emitted/received by the plurality of mm-Wave antenna elements can be achieved in the first direction with aid of the plane lens.
